(19) United States
(12) Patent Application Publication
(10) Pub. No.: US 2012/0043789 A1
(43) Pub. Date: Feb. 23, 2012

(54) ARTICLE HANGING STRUCTURE MOUNTED TO AUTOMOBILE SEAT BACKREST

(76) Inventor: Ting-Po LEE, Taoyuan City (TW)

(21) Appl. No.: 12/860,935

(22) Filed: Aug. 23, 2010

(51) Int. Cl. B60N 2/44

(52) U.S. Cl. 297/188.06; 297/188.04

(57) ABSTRACT

An article hanging structure is mounted to a seat backrest of an automobile and includes a fitting cover having a top end forming a through hole, a positioning member mounted to a side or back of the fitting cover, and a connection member mounted to an article and corresponding to the positioning member. The fitting cover is fit over the seat backrest to allow a headrest of the seat to extend through the through hole and the fitting cover laid flat on the seat backrest. The article, which is for example a facial tissue box, a trash bag, or a cup holder, is allowed to hang on the side or back of the seat backrest through coupling between the connection member and the positioning member, so as to realize efficient use of the internal space of an automobile, make arrangement of articles easy and convenient, and allow for easy access.

### (A) TECHNICAL FIELD OF THE INVENTION

The present invention generally relates to an article hanging structure mounted to an automobile seat backrest, and more particularly to an article hanging structure that allows an article, such as a facial tissue box, a trash bag, or a cup holder, to be hung on a side surface or a back surface of a seat backrest for efficient use of internal space of an automobile to realize an aesthetic and convenient-to-use of articles inside the automobile.

### (B) DESCRIPTION OF THE PRIOR ART

An automobile, especially a passenger car, is usually not provided with specific design of accommodation space for a facial tissue box, a trash bag, or the likes inside the automobile. Thus, a user must first identify a proper location inside the automobile, such as the floor area in front of the front seat or back seat, doors, or back windshield, where an article holder can be placed. Alternatively, an article holder can be attached to the backrest of the front seat or back seat of the automobile. No matter where the article holder is placed, it is not possible for a single article holder to be easily accessed from both the front seat and the back seat. To solve such a problem, some manufacturers provide a magnetically attached facial tissue box that is attached to the roof of an automobile by a magnet, or an article holder is attached to the seat backrest by being tightened by a cable or rope. These arrangements, although effective, at least to some extents, in solving the above described problem for allowing easy access from both the front and back seats, are not aesthetic ones and may not be properly secured, making them impractical solutions. Thus, the present invention aims to provide a solution to such problems in order to make articles positioning and arrangement inside an automobile easy and convenient and readily accessed by passengers everywhere inside the automobile.

### SUMMARY OF THE INVENTION

The primary objective of the present invention is to provide an article hanging structure mounted to an automobile seat backrest to allow an article, such as a facial tissue box, a trash bag, or a cup holder, to be hung on a side surface or a back surface of a seat backrest through engagement between a connection member formed on the article and a positioning member fixed to a cover that is in turn coupled to the seat backrest, so as to realize efficient use of the internal space of an automobile and make the positioning and arrangement of articles easy and convenient inside the automobile.

The article hanging structure can be mounted to a seat backrest of an automobile and comprises a fitting cover, which has a top end forming a through hole, a positioning member selectively mounted to a side surface of the fitting cover, and a connection member mounted to an external article and corresponding to the positioning member, wherein the fitting cover is fit over the seat backrest of the automobile in such a way that a headrest that is arranged atop the seat backrest is received through the through hole and the fitting cover is laid flat on the seat backrest to allow the article, which can be for example a facial tissue box, a trash bag, or a cup holder, to hang on a side surface of the seat backrest through engagement and coupling between the connection member formed on the article and the positioning member of the fitting cover, so as to realize efficient use of the internal space of an automobile, make the positioning and arrangement of articles easy and convenient inside the automobile, and allow for easy access and use by passengers of both front and back seats of the automobile.

In the article hanging structure according to the present invention, the positioning member mounted to the fitting cover and the connection member mounted to the article comprise Velcro fastener, magnet, or a fastening band.

In the article hanging structure according to the present invention, the positioning member that is mounted to the fitting cover can be attached to a back surface of the fitting cover, so that when the fitting cover is fit over a seat backrest of an automobile, an article, such as a facial tissue box, a trash bag, or a cup holder, can be hung on a back surface of the seat backrest.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is an exploded view of an article hanging structure according to a first embodiment of the present invention.

FIG. 2 is an assembled view of the article hanging structure according to the first embodiment of the present invention.

FIG. 3 is an exploded view of an article hanging structure according to a second embodiment of the present invention.

FIG. 4 is an exploded view of an article hanging structure according to a third embodiment of the present invention.

FIG. 5 shows another example of the use of the article hanging structure according to the present invention.

FIG. 6 shows a further example of the use of the article hanging structure according to the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

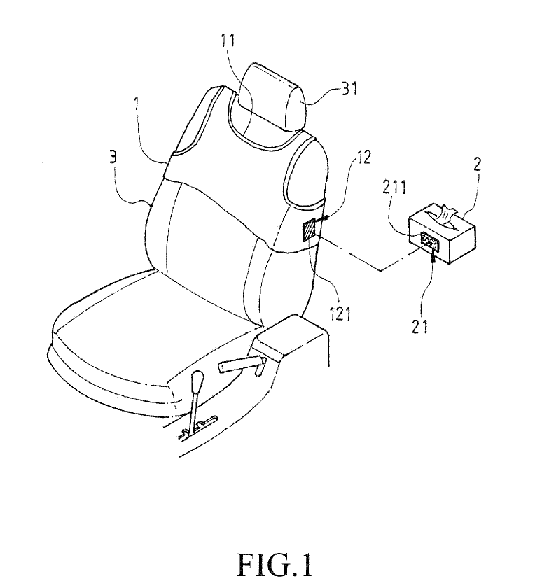

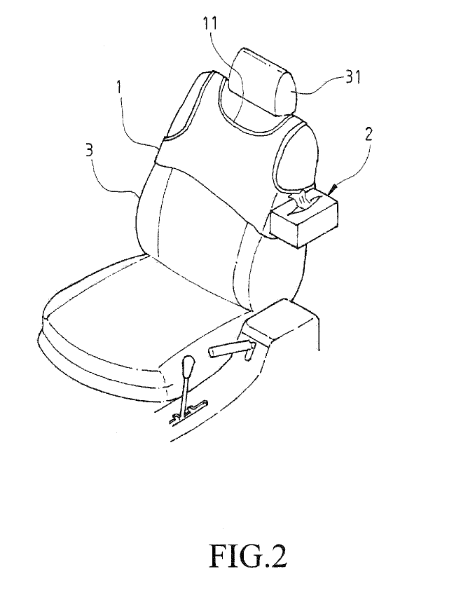

Referring to FIGS. 1 and 2, which show, respectively, an exploded view and an assembled view of an article hanging structure according to a first embodiment of the present invention, the article hanging structure of the present invention comprises a fitting cover 1, which has a top end forming a through hole 11. (In the embodiment illustrated, the fitting cover 1 is a vest or is of a shape of lovely garment.) The fitting cover 1 has a side surface to which a positioning member 12 is mounted. In the first embodiment of the present invention, the positioning member 12 comprises a female part 121 of Velcro fastener.

A connection member 21 is mounted to an article 2 (which in the embodiment illustrated is a facial tissue box) and corresponds to the positioning member 12 of the fitting cover 1. The connection member 21 can be for example a male part 211 of Velcro fastener.

With such an arrangement, to use, the fitting cover 1 is fit over a seat backrest 3 of an automobile.

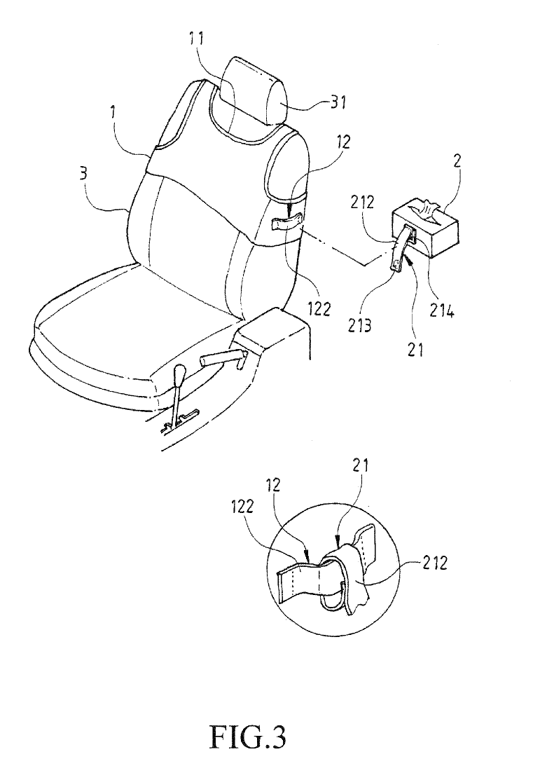

Referring to FIG. 3, which shows an exploded view of an article hanging structure according to a second embodiment of the present invention, in the second embodiment, the fitting cover 1 has a side surface to which a positioning member 12 is mounted and the positioning member 12 comprises a horizontally extending mounting band 122 that has opposite ends fixed to the fitting cover 1 through sewing or adhesives.

A connection member 21 is mounted to an article 2 and corresponds to the positioning member 12 of the fitting cover 1. The connection member 21 comprises a vertically extending fastening band 212. The fastening band carries female and male parts 213, 214 of Velcro fastener.

With such an arrangement, to use, the fitting cover 1 is fit over a seat backrest 3 of an automobile in such a way that a headrest 31 that is arranged atop the seat backrest 3 is received through the through hole 11 and the fitting cover 1 is laid flat on the front and back sides of the seat backrest 3. An article 2, which can be for example a facial tissue box, a trash bag, or a cup holder, is thus allowed to hang on a side surface of the seat backrest 3 through coupling between the connection member 21 formed thereon and the positioning member 12 of the fitting cover 1 (which is realized by extending the fastening band 212 through the mounting band 122 to allow the male and female Velcro parts 213, 214 to engage each other to thereby hang the fastening band 212 on the mounting band 122), so as to realize efficient use of the internal space of an automobile, make the positioning and arrangement of articles 2 easy and convenient inside the automobile, and allow for easy access and use by passengers of both front and back seats of the automobile.

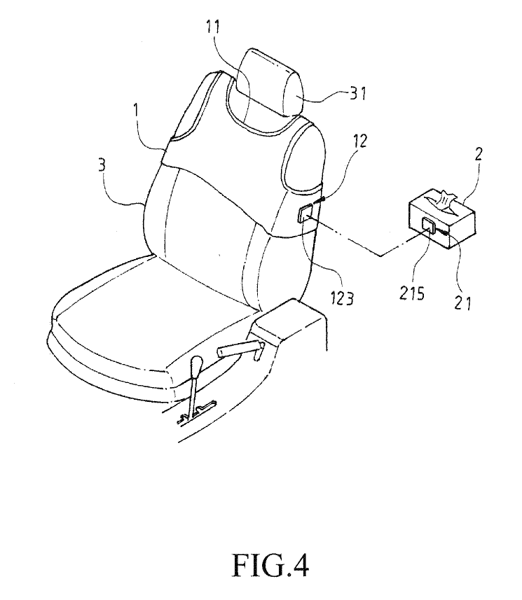

Referring to FIG. 4, which shows an exploded view of an article hanging structure according to a third embodiment of the present invention, in the third embodiment, the fitting cover 1 has a side surface to which a positioning member 12 is mounted and the positioning member 12 comprises a magnet 123.

A connection member 21 is mounted to an article 2 and corresponds to the positioning member 12 of the fitting cover 1. The connection member 21 comprises a magnet 215.

With such an arrangement, to use, the fitting cover 1 is fit over a seat backrest 3 of an automobile in such a way that a headrest 31 that is arranged atop the seat backrest 3 is received through the through hole 11 and the fitting cover 1 is laid flat on the front and back sides of the seat backrest 3. An article 2, which can be for example a facial tissue box, a trash bag, or a cup holder, is thus allowed to hang on a side surface of the seat backrest 3 through coupling between the connection member 21 formed thereon and the positioning member 12 of the fitting cover 1 (which is realized through magnetic attraction between the magnet 213 and the magnet 215), so as to realize efficient use of the internal space of an automobile, make the positioning and arrangement of articles 2 easy and convenient inside the automobile, and also to allow for easy access and use by passengers of both front and back seats of the automobile.

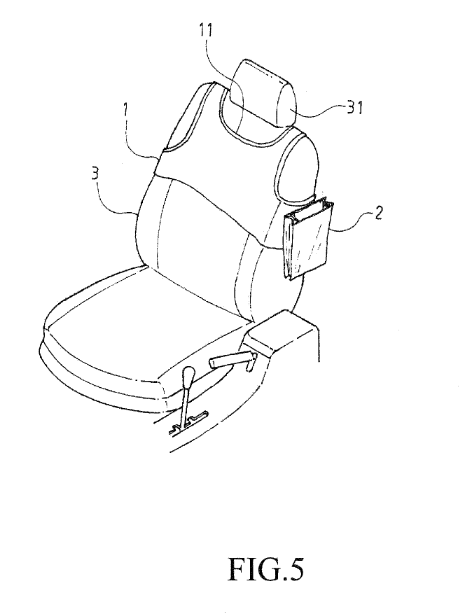

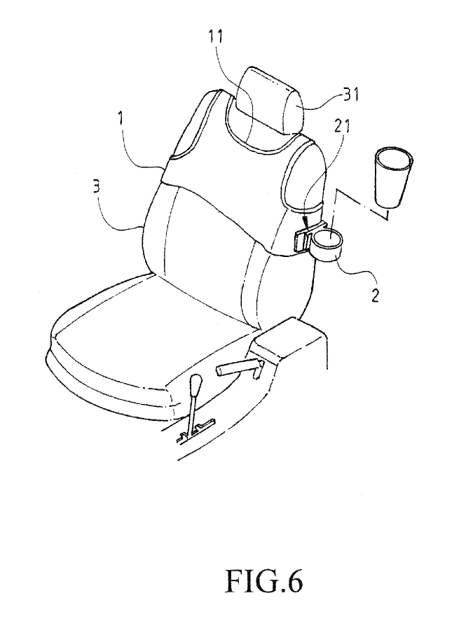

Referring to FIGS. 5 and 6, examples of use of the article hanging structure according to the present invention are shown. The article hanging structure of the present invention, besides being used to hold a facial tissue box as illustrated in the previous embodiments, can also be used to other articles 2, such as trash bag shown in FIG. 5 or a cup holder shown in FIG. 6 for receiving disposed trashes or a cup to thereby enhance the practical value of the present invention.

In the previous embodiment, the positioning member mounted to the fitting cover and the connection member mounted to an external article can both be of different forms or structures. Further, the positioning member 12 of the fitting cover 1 can be mounted to a back surface of the fitting cover 1, so that when the fitting cover 1 is fit over a seat backrest 3 of an automobile, an article 2, such as a facial tissue box, a trash bag, or a cup holder, can be hung on a back surface of the seat backrest 3 to provide a different way of use of the present invention. Thus, it is understood that the embodiments given previously are for illustration only, not to limit the scope of the present invention. Modification and change can be made on the embodiments of the article hanging structure discussed previously without departing from the scope of the present invention.

In summary, the present invention provides an article hanging structure that is composed of a positioning member mounted to a fitting cover and a connection member formed on an external article to be hung for the purposes of hanging an article, such as a facial tissue box, a trash bag, or a cup holder, on a side surface or a back surface of a seat backrest of an automobile through the engagement or coupling between the connection member of the article and the positioning member of the fitting cover, so as to realize efficient use of the internal space of the automobile, make the positioning and arrangement of articles inside the automobile easy and convenient, allow for easy access of the article so hung.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. An article hanging structure adapted to mount to a seat backrest of an automobile, comprising a fitting cover, which has a top end forming a through hole, a positioning member selectively mounted to a side surface or a back surface of the fitting cover, and a connection member adapted to mount to an external article and correspond to the positioning member, wherein the fitting cover is adapted to fit over the seat backrest of the automobile to allow the external article to hang on the side surface or the back surface of the seat backrest through coupling between the connection member mounted to the article and the positioning member mounted to the fitting cover, so as to realize efficient use of the internal space of an automobile, make positioning and arrangement of articles easy and convenient inside the automobile, and allow for easy access and use.

2. The article hanging structure according to claim 1, wherein the positioning member mounted to the fitting cover and the connection member mounted to the external article comprise male and female parts of Velcro fastener.

3. The article hanging structure according to claim 1, wherein the positioning member mounted to the fitting cover and the connection member mounted to the external article comprise magnets.

4. The article hanging structure device according to claim 1, wherein the positioning member mounted to the fitting cover comprises a horizontally extending mounting band that has opposite ends fixed to the fitting cover and wherein the connection member mounted to the external article comprises a vertically extending fastening band, which is extendible through the mounting band for coupling to and hanging on the mounting band.

5. The article hanging structure according to claim 4, wherein the fastening band comprises female and male parts of Velcro fastener attached thereto, whereby after extending through the mounting band, the fastening band is hung on the mounting band through engagement between the male and female parts of Velcro fastener.
